(19) United States
(12) Patent Application Publication
(10) Pub. No.: US 2005/0104452 A1
(43) Pub. Date: May 19, 2005

(54) Key control of device that is dependent upon current direction

(75) Inventor: Mikael Wallerstrom, Trollhattan (SE)

Correspondence Address: OSTROLENK FABER GERB & SOFFEN, 1180 AVENUE OF THE AMERICAS, NEW YORK, NY, 100368403, US

(73) Assignee: Saab Automobile AB

(21) Appl. No.: 10/991,984

(22) Filed: Nov. 18, 2004

(30) Foreign Application Priority Data
Nov. 18, 2003 (SE) 0303060-8

(51) Int. Cl. B60L 3/00

(52) U.S. Cl. 307/10.1

(57) ABSTRACT

A locking device for controlling an actuator (13) with key lock (1), comprising key-activated switches (6,8) for connecting the actuator (13) to the supply voltage (10) in such a way that it can be disconnected, control unit-activated switches (14) for alternating and mutually exclusive connection of current to the actuator (13) in a first and a second direction.

### TECHNICAL FIELD

The present invention relates to a method and an arrangement for controlling a device that is dependent upon current direction in an electrical circuit, preferably in a safety-critical system, by means of the position of a key.

### BACKGROUND

Mechanical key locks ate being replaced increasingly by electromechanical or electrical key locks that have a key with electronic components and a position function that is dependent upon shape. The electronic components in the key activate the locked functions when the key is in the correct position in a key seat in the lock. Such electrical key locks are found, for example, in cars with ignition locks and steering locks. With an electrical steering lock, the steering of the vehicle is usually locked by a bolt that is moved between a closed and an open position by means of a motor, a solenoid or similar electrically controlled component. The steering lock application is an example of a safety-critical system, in which it must be ensured that the steering of the vehicle is always unlocked when the electrical key lock is in the unlocked position.

### BACKGROUND ART

The patent publication WO 01/23229 (Marquardt GMBH) shows an example of an electrical steering lock that addresses this safety problem. This publication describes an electrical steering lock that is locked by means of an actuator that can be switched electrically between a locked and an unlocked state. The electrical steering lock has an electrical circuit with constant supply of the current that is required to put the steering lock in an unlocked state, and a separate electrical circuit for supplying the current that is required to put the steering lock in a locked state. In the locking electrical circuit, there are switches that break the locking electrical circuit when a key is in a certain position in a key seat. In this way, a control processor that controls the actuator is prevented from changing the steering lock to a locked position when the key is in a particular position, but can always change the actuator to an unlocked state. This publication is hereby incorporated, by means of this reference, as a description of the known part of the implementation of the invention.

This prior art has limitations in that the correct key position only prevents changing the actuator to one state (locked), while changing the actuator to the other state (unlocked) is allowed constantly in any key position. The safety function in this known technology is thus a switch that opens the locking electrical circuit when the key is in the unlocking position and thereby prevents unintentional locking of the steering. A short circuit can, however, arise in the switches or in some other location, possibly simultaneously with a bit error in the microprocessor, so that the locking electrical circuit can still pass current through the actuator and unintentionally lock the steering. In the technical solution that is described in WO 01/23229, switches are used in the form of relays with two positions, that is each relay is always activated in one or the other position. In order not to have the actuator (the motor 4) permanently activated, after the completion of activation, the microprocessor must make both the relays connect the motor's feeds to the same voltage. A short circuit to voltage in the relay or the feed that operates the motor for the locked position means that the motor immediately moves the bolt to the locked position, even when this is not the intention.

According to the technical solution in WO 01/23229, there is, in addition, no way of detecting whether the safety function has failed due to a fault, without additional information and logic. If, for example, due to a fault, there is a constant voltage at the input to the relay for supplying voltage for locking, it is not possible to detect this by the microprocessor or via function interference. In other words, in the event of such a fault the whole safety function is lost, without the user, in this case the driver of the car, detecting function interference or other warning.

### OBJECT OF THE INVENTION

The present invention aims to solve the general problem of ensuring correct control of an electrical or electromechanical actuator that is operated in response to a digitally controlled electronic locking system.

Aspects of the problem that the invention intends to solve are:
ensuring control of the current direction in an electrical circuit to an electrical component that is dependent upon current direction.
ensuring, in a digitally controlled electronic locking system, that a bit fault is prevented from giving rise to incorrect controlling of a current direction.
achieving the ability to detect function interference in the control of the actuator.

### SUMMARY OF THE INVENTION

According to the invention, the above-mentioned problem and limitations are eliminated and this is achieved by means of a locking device with key-activated switches for a supply voltage that can be disconnected, together with control unit-activated switches that are arranged to be connected to an actuator of some kind, preferably a motor, solenoid or the like. The control unit-activated switches are connected symmetrically to the actuator in order to allow an electrical current through the actuator in different directions alternately. The control unit-activated switches are electrically arranged so that they are mutually exclusive. In the event of an incorrect control signal from the control unit, or in the event of a short circuit to the earth potential or the supply voltage, current is passed to earth while the actuator is without current. The mutually exclusive conducting of current in different directions is found in different embodiments, realized with key-activated switches, with control unit-activated switches, in the control unit's predetermined conditions, and in the conducting of the supply voltage from the key-activated switches.

The invention therefore achieves a fail-safe control of current to an actuator, in which faults in the control or short circuits are prevented from unintentionally activating the actuator. Such faults are also able to be detected by loss of function that can be observed.

Different embodiments of the invention comprise the following aspects:

A locking device for controlling an actuator that is dependent upon current direction, comprising a key-receiving device (4) arranged to receive a key (2), with the key-receiving device (4) comprising a first key-activated switch (6) that is arranged to close a first electrical circuit (7) when the said key is not in a predetermined position in the key-receiving device (4); a control unit (16) that emits a first control signal (L) for activating the supply of current in a first direction to the said actuator (13) and a second control signal (U) for activating the supply of current in a second direction to the said actuator (13) in response to predetermined conditions; with a second key-activated switch (8) that is arranged to close a second electrical circuit (9) when the said key (2) is in a predetermined position in the key-receiving device (4); first control unit-activated switches (14-L) that are arranged to close the said first electrical circuit (7) when the said control unit (16) emits the said first control signal (L) and second control unit-activated switches (14-U) that are arranged to close the said second electrical circuit (9) when the said control unit (16) emits the said second control signal (U). The first (14-L) and the second (14-U) control unit-activated switches are preferably arranged in such a way that they must be mutually exclusively open or closed in order for a current to be able to pass through the actuator (13).

This can be realized in such a way that the actuator (13) is connected by its electrical connections between a pair of first control unit-activated switches (14-L) that are in turn connected to conduct current in the said first electrical circuit (7) in a first direction between the earth potential (GND) and the supply voltage (10); and the actuator (13) is connected by its electrical connections between a pair of second control unit-activated switches (14-U) that are in turn connected to conduct current in the said second electrical circuit (9) in a second direction between the earth potential (GND) and the supply voltage (10). By this means, it can be arranged that one of the first control unit-activated switches (14-L) is connected to the earth potential (GND), to one connection of the actuator (13) and to one of the second control unit-activated switches (14-U) that is connected to a supply voltage (10,6) that can be disconnected; and the second of the first control unit-activated switches (14-L) is connected to a supply voltage (10,8) that can be disconnected, to the second connection of the actuator (13) and to the second of the second control unit-activated switches (14-U) that is connected to the earth potential (GND).

In different embodiments, it is arranged that:
the said control unit is arranged in such a way that the said first control signal (L) and the said second control signal (U) are mutually exclusive;
the said control unit is arranged in such a way that the said first control signal (L) and the said second control signals (U) satisfy the logical condition
(L=Active AND U=Inactive) OR (L=Inactive AND U=Active);
the said first key-activated switch (6) and the said second key-activated switch (8) are arranged in such a way that they are mutually exclusively switched on or switched off;
means (28) are arranged for ensuring that a current in the said first direction to the actuator (13) via the said first key-activated switch (6) is mutually exclusive with a control signal (U) from the control unit (16) for activating a current flow in the said second direction;
means (26) are arranged for ensuring that a current in the said second direction to the actuator (13) via the said second key-activated switch (8) is mutually exclusive with a control signal (L) from the control unit (16) for activating a current flow in the said first direction;
means (30) are arranged for ensuring that a current in the said first direction to the actuator (13) via the said first key-activated switch (6) is mutually exclusive with a current in the said second direction to the actuator (13) via the said second key-activated switch (8);
the said control unit-activated switches (14) are connected in an H-bridge across the actuator (13);
the said control unit-activated switches (14) are realized in the form of transistors;
the said control unit-activated switches (14) are realized in the form of relay elements;
the said control unit (16) is arranged for connection (22, 24) and reading off of status signals from electrical leads;
the said control unit (16, 31) is arranged for connection of a control signal to the control unit;
the said control unit (16, 31) comprises a first set of control signal inputs (32) for first control signals A1 . . . AN and a second set of control signal inputs (34) for second control signals B1 . . . BN, where N=1,2,3 . . . .

In a general embodiment, the locking device according to the invention comprises a control unit (31): with a first input IN1 which is arranged to be connected to the supply voltage (10) via the first key-activated switch (6) in such a way that it can be disconnected and with a second input IN2 which is arranged to be connected to the supply voltage (10) via the second key-activated switch (8) in such a way that it can be disconnected;
with a first input/output I/O1 which is arranged to be connected to a first electrical terminal on the said actuator (13) and with a second input/output I/O2 which is arranged to be connected to a second electrical terminal on the said actuator (13);
with an input arranged to be connected to the earth potential (GND);
with inputs arranged for a first set of control signals (A1 . . . AN) and a second set of control signals (B1 . . . BN);
with the control unit (31) being arranged to connect electrically the input IN1 to the input/output I/O1 and to connect the input/output I/O2 to the earth potential GND if a number of first predetermined conditions are fulfilled; and
with the control unit (31) being arranged to connect electrically the input IN2 to the input/output I/O2 and to connect the input/output I/O1 to the earth potential GND if a number of second predetermined conditions are fulfilled.

### BRIEF DESCRIPTION OF THE DRAWINGS

The invention will be described in greater detail below with reference to the attached drawings in which:

FIG. 1 shows an outline drawing of a key with a fit in a key seat dependent upon shape and a control device for controlling an electrical actuator according to an exemplifying embodiment of the invention;

FIGS. 2-4 show schematically exemplifying embodiments of the invention.

### DESCRIPTION OF EMBODIMENTS OF THE INVENTION

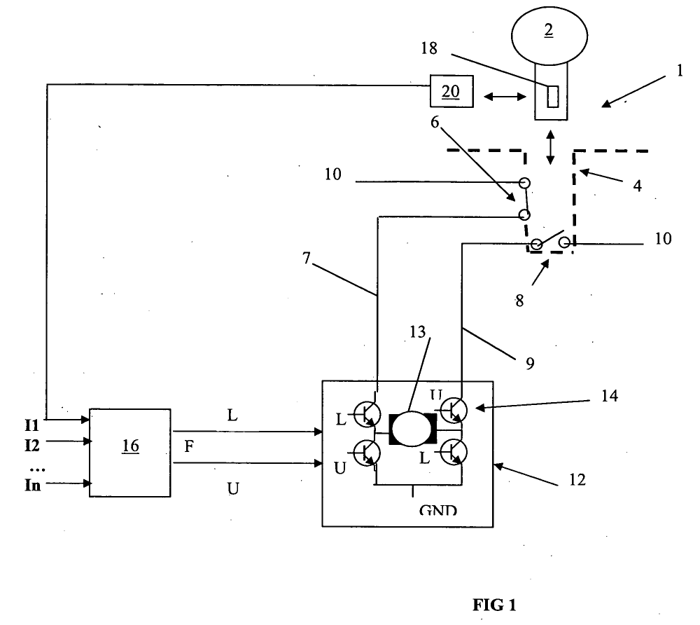

FIG. 1 shows schematically, in an exemplifying embodiment of the invention, a key lock 1 with a key 2 that has a fit in a key-receiving device 4 that is dependent upon shape. In FIG. 1, the key has been removed from the lock and the circuit is in locking mode.

The key-receiving device 4 is provided with a first key-activated switch 6 arranged to close a locking electrical circuit 7 when the key 2 is not in a predetermined position in the key-receiving device (“key removed”), which key-receiving device is intended for the key when it is in the lock in a preferably unlocking position, and the lock is thus in a locking state. When the key 2 is placed in the said predetermined position in the lock (“key inserted”), this first key-activated switch 6 is opened and current is thereby prevented from passing through the locking electrical circuit.

The key-receiving device 4 is also provided with a second key-activated switch 8 arranged to close an unlocking electrical circuit 9 when the key 2 is placed and remains in the said predetermined position in the key-receiving device (“key inserted”), which key-receiving device is intended for the key when it is in its preferably unlocked position in the lock, and the lock is thus in an unlocking state. When the key 2 is removed and thus is not in the said predetermined position in the lock, this second key-activated switch 8 is opened and current is thereby prevented from passing through the unlocking electrical circuit.

The locking electrical circuit 7 and the unlocking electrical circuit 9 are connected to a control unit-activated switching device 12 that comprises control unit-activated switches 14 with locking switches L and unlocking switches U. The locking electrical circuit 7 is connected to an actuator 13 that is dependent upon current direction, which actuator is connected to the supply voltage 10 via an earth potential GND and via the said locking switches 6,L, and the actuator 13 is thereby able to be caused to operate in a predetermined locking direction. In the same way, the unlocking electrical circuit 9 is connected to the actuator 13 that is dependent upon current direction, which actuator is connected to the supply voltage 10 via the earth potential GND and the said unlocking switch 8,U, and the actuator 13 is thereby able to be caused to operate in a predetermined unlocking direction.

The actuator 13 that is dependent upon current direction is preferably, for example, in the form of an electromechanical device, for example a motor M as shown in FIG. 1, a solenoid or a relay device, but can also be a completely electrical or electronic device.

In the exemplifying embodiment in FIG. 1, the control unit-activated switching device 12 is designed with switches 14 in the form of transistors that are connected to the locking L and unlocking U electrical circuits in an H-bridge across the actuator 13. The transistors' connections are connected to control outputs F on a control unit 16. A locking control output L is connected to the connections of the locking transistors L and an unlocking control output is connected to the unlocking transistors U. When the locking control output L has an active signal L, the locking transistors L remain in a current-passing state and allow current to pass through the locking electrical circuit 7, while the unlocking transistors U do not allow current to pass through the unlocking electrical circuit 9. In the same way, when the unlocking control output U has an active signal U, the unlocking transistors U remain in a current-passing state and allow current to pass through the unlocking electrical circuit 9, while the locking transistors L do not allow current to pass through the locking electrical circuit 7.

The control unit 16 has a number n of inputs I1, I2 . . . In for different input signals that can be used in accordance with predetermined rules for controlling locking or unlocking. In the embodiment of the invention according to FIG. 1, the key is provided with a key information device 18, which can, for example, be a data memory or a resonance circuit, which can be read off via a wireless or galvanic communication connection by means of a key information reader 20. The key information reader 20 is connected to an input I1, I2 . . . in the control unit and can communicate with the control unit, and the input signal from the key information reader is used, if necessary together with other input signals, for the said control of unlocking or locking. The invention can be designed in such a way that the key-activated switches 6, 8 are activated by means of the key information device 18 and the key information reader 20, for example using transponder technology and means for actuating the switches 6, 8. In different embodiments of the invention, input signals to the control unit 16 are used from various status sensors, together with or completely without key information.

According to the invention, in order to achieve a current in the locking electrical circuit 7, it is necessary for the key 2 not to be in the position for unlocking and hence for the key-activated locking switch 6 to be closed, and it is necessary for the control unit 16 at the same time to send an active locking control signal L to the control unit-activated locking switch L and to have an inactive unlocking control signal U. In a corresponding way, to achieve a current in the unlocking electrical circuit 9, it is necessary for the key 2 to be placed in the position for unlocking and hence for the key-activated unlocking switch 8 to be closed, and it is necessary for the control unit 16 at the same time to send an active unlocking control signal U to the control unit-activated switch U and to have an inactive locking control signal L. The control signals from the control unit 16 at the output F must thus satisfy the Boolean condition (L=Active AND U=Inactive) OR (L=Inactive AND U=Active) in order to activate the actuator. Together with the key-activated switch for voltage supply, the risk of unintentional activation of the actuator due to an individual bit error or short-circuit is considerably reduced.

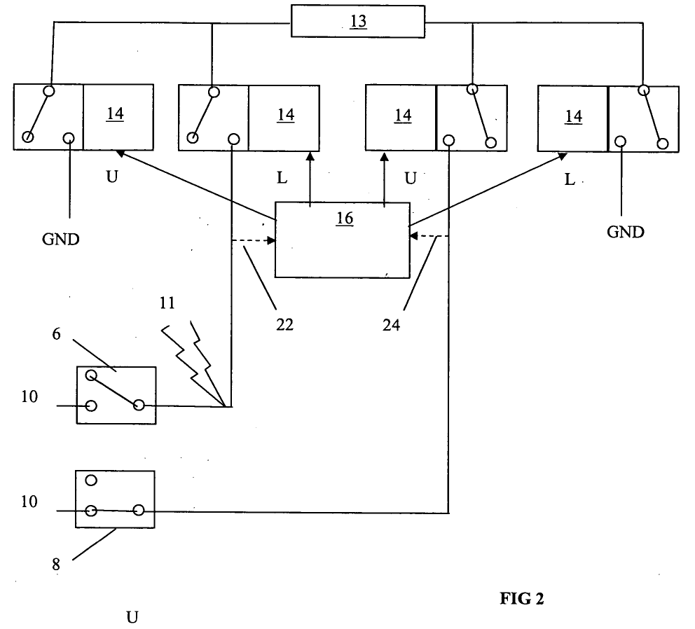

FIG. 2 shows an exemplifying embodiment of the invention in which the control unit-activated switches are realized by means of relays or the like. Using the same conventions as in FIG. 1, FIG. 2 shows the key-activated switches in the position with the key inserted, that is in the unlocking position. Using the same reference numerals as in FIG. 1, in FIG. 2 a first key-activated switch 6 in a locking electrical circuit is connected to the supply voltage 10 and a first control unit-activated switch 14-L in the locking electrical circuit, which first switch is in turn connected to an actuator 13. In the locking electrical circuit, the actuator 13 is, in addition, connected to a second control unit-activated switch 14-L, which is in turn connected to earth. A control unit 16, with control outputs for locking control signals L, is connected to the said first and second switches 14-L in the locking electrical circuit.

In a corresponding way, a second key-activated switch 8 in an unlocking electrical circuit is connected to the supply voltage 10 and a first control unit-activated switch 14-U in the unlocking electrical circuit which first switch is in turn connected to the actuator 13 on the same connection as the locking electrical circuit's first switch 14-L. In addition, the actuator 13 is connected, on the same connection as the locking electrical circuit's second switch 14-L, to a second control unit-activated switch 14-U in the unlocking electrical circuit, which second switch is in turn connected to earth.

When the control unit's locking control signal L is active, the locking switches 14-L are caused to close the locking electrical circuit and when the key-activated switch 6 also closes the locking electrical circuit, that is when the key is removed from its unlocking position in the lock, the actuator 13 is activated into a locking state. In order for current to be able to pass to the actuator through the locking electrical circuit, it is also necessary for the control unit's unlocking control signal U to be inactive, so that the unlocking switches 14-U remain in the open position. Otherwise, the current goes directly to the earth potential GND via the unlocking switches 14-U.

In a corresponding way, when the control unit's unlocking control signal U is active, the unlocking switches 14-U are caused to close the unlocking electrical circuit and when the key-activated switch 8 also closes the unlocking electrical circuit, that is when the key is placed in its unlocking position, the actuator 13 is activated into an unlocking state. As in the case for locking, in order for current to be able to pass to the actuator through the unlocking electrical circuit, it is also necessary for the control unit's locking control signal L to be inactive, so that the locking switches 14-L remain in the open position. Otherwise, once again the current goes directly to the earth potential GND via the locking switches 14-L.

In different embodiments, the locking or unlocking control signals from the control unit 16 can be divided into two, three or four separate signals (L,U; L1,L2,U; L,U1,U2; L1,L2,U1,U2) which, together with the key-activated switches 6, 8 in the correct combination in accordance with a predetermined logical condition, close the locking or unlocking electrical circuit through the activator.

Any short-circuit 11 to voltage or earth in any one of the switches or leads cannot by itself give rise to activation of the actuator. In order to operate the actuator in any current direction, an active control is required by means of control signals from the control unit. The result of a fault is either that activation is carried out in accordance with the conditions of the control logic or that activation is not carried out and the fault can be observed by a user.

FIG. 2 shows schematically inputs with connections 22, 24 to the control unit from the supply voltage in the locking (connection 22) or unlocking (connection 24) electrical circuits in embodiments of the invention. In this embodiment, the control unit also comprises status reading from the connections 22, 24 and functionality for the detection of faults in signals from these connections. A control condition could then be that, in the normal situation, the switches are to be mutually exclusive and that there is then the ability to detect or take action when one of the switches or its leads has a fault which results in a short circuit to the supply voltage.

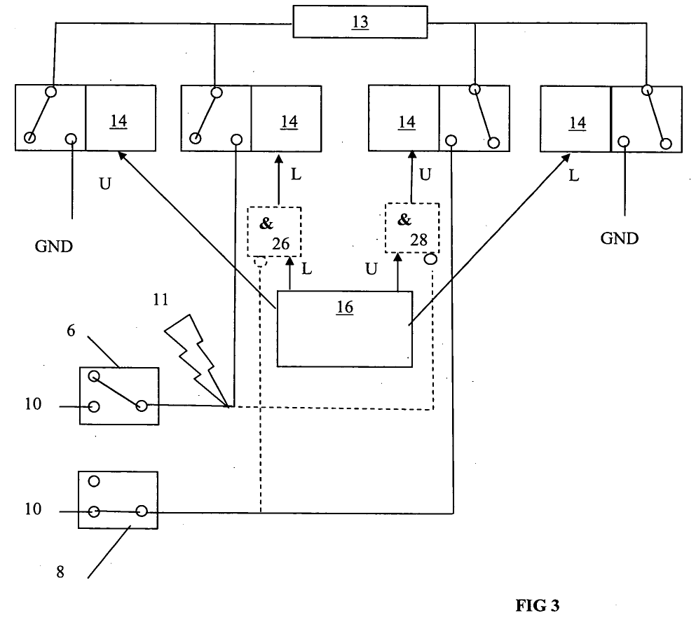

FIG. 3 shows a variant of the embodiment according to FIG. 2 with connection elements that enable detection of faults in the safety function, where the fault consists of a constant voltage supply to any one of the locking and unlocking electrical circuits. The fault is detected by observation of the loss of function. In FIG. 3, a first AND gate 26 with an inverting input is connected by its inputs to the unlocking key-activated switch 8 and the locking control signal output L of the control unit 16 and is connected by its output to the locking first control unit-activated switch 14-L. The AND gate 26 is connected in such a way that the inverted signal from the unlocking key-activated switch 8 AND active locking control signal L from the control unit 16 generate an active locking output signal L from the AND gate 26. In a corresponding way, a second AND gate 28 with an inverting input is connected to the locking key-activated switch 6 and the unlocking control signal output U of the control unit 16 and is connected by its output to the unlocking first switch 14-U that is activated by a control signal. The AND gate 28 is connected in such a way that the inverted signal from the locking key-activated switch 6 AND active unlocking control signal U from the control unit 16 generate an active unlocking output signal U from the AND gate 26. In this way, the switches are mutually exclusive and allow detection of faults through function interference.

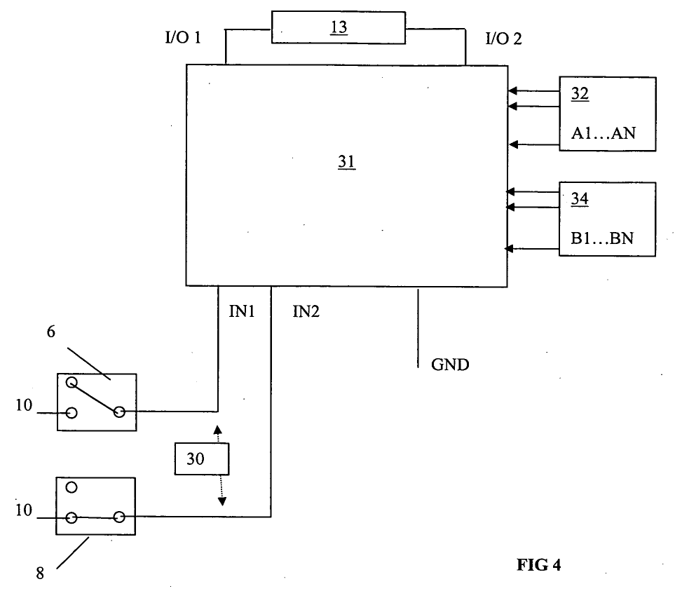

FIG. 4 shows in a general block diagram the control of the actuator 13 by means of a key-activated switch 6 for “key removed” and hence locking mode and a switch 8 for “key inserted” and hence unlocking mode, and a control unit 31 in the form of a logic block that is connected to the actuator 13. As in FIG. 2 and FIG. 3, the key-activated switches are shown in the unlocking position. The key-activated switches 6,8 are arranged in such a way that they are mutually exclusively switched on (closed) or switched off (open), which is shown schematically in FIG. 4 by the block 30 that can comprise logic gates or similar functionality. In the simplest embodiment, the key-activated switches 6,8 are arranged in such a way that one is open when the other is closed and vice versa, as shown above, depending upon whether the key is placed in the lock or not. The supply voltage is connected to the respective input IN1 and IN2 of the control unit 31 via the connection 10 for the key-activated switches 6,8. The actuator 13 is connected to the two inputs/outputs I/O1 and I/O2 of the control unit 31, which is also connected to the earth potential GND. The control unit 31 has also a first set of control signal inputs 32 for first control signals A1 . . . AN and a second set of control signal inputs 34 for second control signals B1 . . . BN, where N=1,2,3 . . . and indicates a cardinal number. In an application of the invention, control signals can be various signals signifying state or signals from sensors that it is wished to use as conditions in the control unit.

The control unit 31 is arranged functionally in such a way that the input IN1 is connected galvanically, that is conducting electrical current, to the input/output I/O1, and the input/output I/O2 is connected to the earth potential GND if a number of first predetermined conditions are fulfilled, and thus allows operation of the actuator in a first current direction, provided that the first key-activated switch 6 is also closed. In the steering lock application, this would result in a locking mode. In the same way, the control unit 31 is arranged in such a way that the input IN2 is connected to the input/output I/O2, and the input/output I/O2 is connected to the earth potential GND if a number of second predetermined conditions are fulfilled, and thus allows operation of the actuator in a second current direction, provided that the second key-activated switch 8 is also closed. In the said steering lock application, this would consequently result in an unlocking mode. The different conditions can be varied to suit the application and requirements and are realized by different types of technology, but the first and second predetermined conditions for operation of the actuator in the said first or second current direction must be mutually exclusive. Similarly, the actual physical or galvanic connections for different current direction circuits can be realized in different ways, but these electrical connections must also be mutually exclusive.

The logic that is to handle the control conditions can be designed in various ways, among other things depending upon what type of fault occurrence is to be monitored. A general example of a logical control condition is:
I/O1=IN1 AND I/O2=GND
IF IN2=inactive Control A1 to AN=active AND Control B1 to BN=inactive
I/O2=IN2 AND I/O1=GND
IF IN1=inactive AND Control B1 to BN=active AND Control A1 to AN=inactive
N=1,2,3 . . . .

The invention can be utilized in various applications where there is preferably a safety-critical function that depends on the operation of an actuator in a certain current direction. In the exemplifying embodiments, an example has been shown with a key lock, for example a steering lock in a vehicle. The invention is primarily suited for antitheft applications in vehicles, but other applications can be doors, garage doors, pumps, wireless control devices in vehicles, locking of drive shafts, etc, with embodiments of the invention that can be varied within the framework of the attached patent claims.

1. A locking device for controlling an actuator that is dependent upon current direction, comprising
a first electrical circuit; a key-receiving device configured to receive a key, the key-receiving device comprising a first key-activated switch that is arranged and operable to close the first electrical circuit when the key is not in a predetermined position in the key-receiving device;
a second electrical circuit, the key-receiving device further comprising a second key-activated switch that is arranged and operable to close the second electrical circuit when the key is in the predetermined position in the key-receiving device;
a control unit that is operable dependent on predetermined conditions to emit a first control signal (L) for activating the supply of current in a first direction to the actuator and that is operable to emit a second control signal (U) for activating the supply of current in a second direction to the actuator,
first control unit-activated switches (14-L) arranged to close the first electrical circuit when the control unit emits the first control signal (L) and second control unit-activated switches (14-U) arranged to close the second electrical circuit when the control unit emits the second control signal (U).

2. Locking device according to claim 1, wherein the first (14-L) and the second (14-U) control unit-activated switches are arranged such that they must be mutually exclusively open or closed in order for a current to be able to pass through the actuator.

3. Locking device according to claim 2, wherein the actuator has first electrical connections connecting the actuator between a pair of the first control unit-activated switches (14-L) and the first control unit-activated switches are connected to conduct current in the first electrical circuit in a first direction between earth potential and a supply voltage; and the actuator also having second electrical connections between a pair of the second control unit-activated switches (14-U) and the second control unit-activated switches are connected to conduct current in the second electrical circuit in a second direction between the earth potential and the supply voltage.

4. Locking device according to claim 3, wherein
a first one of the first control unit-activated switches (14-L) is connected to the earth potential, to one of the first connections of the actuator and to one of the second control unit-activated switches (14-U) and the one of the second control unit-activated switches is connected to a supply voltage that can be disconnected; and
a second one of the first control unit-activated switches (14-L) is connected to a supply voltage that can be disconnected, to the second one of the first connections of the actuator and to the second one of the second control unit-activated switches (14-U) and the second one of the second control unit-activated switches is connected to the earth potential.

5. Locking device according to claim 1, wherein the control unit is arranged such that the first control signal (L) and the second control signal (U) are mutually exclusive.

6. Locking device according to claim 5, wherein the control unit is arranged such that the first control signal (L) and the second control signal (U) satisfy the logical condition
(L=Active AND U=Inactive) OR (L=Inactive AND U=Active).

7. Locking device according to claim 1, wherein the first key-activated switch and the second key-activated switch are arranged such that they are mutually exclusively switched on or switched off.

8. Locking device according to claim 1, further comprising means for ensuring that a current in the first direction to the actuator via the said first key-activated switch is mutually exclusive with a control signal (U) from the control unit for activating a current flow in the second direction.

9. Locking device according to claim 1, further comprising means for ensuring that a current in the second direction to the actuator via the second key-activated switch is mutually exclusive with a control signal (L) from the control unit for activating a current flow in the first direction.

10. Locking device according to claim 1, further comprising means for ensuring that a current in the first direction to the actuator via the first key-activated switch is mutually exclusive with a current in the second direction to the actuator via the second key-activated switch.

11. Locking device according to claim 1, wherein the control unit-activated switches are connected in an H-bridge across the actuator.

12. Locking device according to claim 1, wherein the control unit-activated switches are realized in the form of transistors.

13. Locking device according to claim 1, wherein the control unit-activated switches are in the form of relay elements.

14. Locking device according to claim 1, wherein the control unit is arranged for connection and reading off of status signals from electrical leads.

15. Locking device according to claim 1, wherein the control unit is arranged for connection of a control signal to the control unit.

16. Locking device according to claim 1, wherein the control unit comprises a first set of control signal inputs for first control signals A1 . . . AN and a second set of control signal inputs for second control signals B1 . . . BN, where N=1,2,3 . . . .

17. Locking device according to claim 1, wherein the control unit comprises
a first input IN1 which is arranged to be connected to the supply voltage via the first key-activated switch such it can be disconnected and a second input IN2 which is arranged to be connected to the supply voltage via the second key-activated switch such that it can be disconnected;
a first input/output I/O1 which is arranged to be connected to a first electrical terminal on the actuator and a second input/output I/O2 which is arranged to be connected to a second electrical terminal on the actuator;
an input arranged to be connected to the earth potential;
inputs arranged for a first set of control signals (A1 . . . AN) and a second set of control signals (B1 . . . BN);
the control unit being arranged to electrically connect the input IN1 to the input/output I/O1 and to connect the input/output I/O2 to the earth potential if a number of first predetermined conditions are fulfilled; and
the control unit being arranged to connect electrically the input IN2 to the input/output I/O2 and to connect the input/output I/O1 to the earth potential if a number of second predetermined conditions are fulfilled.

18. Locking device according to claim 17, wherein the control unit is arranged with the general control conditions:
I/O1=IN1 AND I/O2=GND
IF IN2=inactive Control A1 to AN=active AND Control B1 to BN=inactive and
I/O2=IN2 AND I/O1=GND
IF IN1=inactive AND Control B1 to BN=active AND Control A1 to AN=inactive where N=1,2,3 . . . .

19. Locking device according to claim 1, adapted for controlling an actuator for a steering lock in a vehicle.
